(19) United States
(12) Patent Application Publication
(10) Pub. No.: US 2017/0153774 A1
(43) Pub. Date: Jun. 1, 2017

(54) METHOD AND DEVICE FOR DISPLAYING PROGRAM INFORMATION AND TERMINAL APPARATUS

(71) Applicants: LE HOLDINGS (BEIJING) CO., LTD., Beijing (CN); LE SHI INTERNET INFORMATION TECHNOLOGY CORP. BEIJING, Beijing (CN)

(72) Inventor: Jianhong NIE, Beijing (CN)

(21) Appl. No.: 15/241,579

(22) Filed: Aug. 19, 2016

Related U.S. Application Data
(63) Continuation of application No. PCT/CN2016/081827, filed on May 12, 2016.

(30) Foreign Application Priority Data
Nov. 27, 2015 (CN) 201510850338.0

(51) Int. Cl. G06F 3/0482; H04N 21/858; H04N 21/845; H04N 21/482

(52) U.S. Cl. CPC G06F 3/0482; H04N 21/4825; H04N 21/858; H04N 21/845; H04L 67/02

(57) ABSTRACT

The present disclosure discloses a method and a device for displaying program information, and a terminal apparatus, wherein the method includes: detecting an operation of opening a program channel in a live webcast homepage, the homepage including a plurality of program channels; and showing a program list of the carousel video and a current program video of the carousel video acquired, when the program channel opened is a carousel video. The method enables users to intuitively understand the current playing progress of the carousel video, helps the users determine whether to continuously watch the carousel video, and pushes the played programs and programs to be played to the users for the users to select.

### CROSS REFERENCE TO RELATED APPLICATIONS

This application is a continuation application of PCT international application No. PCT/CN2016/081827, filed May 12, 2016, which claims priority to Chinese Patent Application No. 201510850338.0, filed Nov. 27, 2015. The entire contents of these applications are incorporated herein by reference.

### TECHNICAL FIELD

The present disclosure belongs to the field of internet, and particularly, relates to a method and a device for displaying program information, and a terminal apparatus.

### BACKGROUND

With the continuous development of mobile internet technologies, more and more users watch video programs and live videos through video applications. When the user is watching a network video, the user clicks a corresponding program name, and enters a corresponding playing page to watch the program. Links of other related programs will be displayed for the user to select in the playing page, or the links of other related programs will be displayed for the user to select after the current program is completely played.

With the further development of network videos, there appears a program channel called as carousel video, which integrates programs mutually related in contents, and sequentially plays the programs in a rolling manner in a certain period of time. However, the user, after entering the carousel video, does not know specific information of the program being played currently, and thus cannot determine whether to continuously stay at this carousel video to watch the current program.

### SUMMARY

Accordingly, the embodiments of the present disclosure provide a method and a device for displaying program information, and a terminal apparatus, to solve the technical problem of the prior art that the user cannot know the program information being played currently after entering the carousel video.

In order to solve the foregoing technical problem, the present disclosure discloses a method for displaying program information, including: detecting an operation of opening a program channel in a live webcast homepage, the homepage including a plurality of program channels; and showing a program list of the carousel video and a current program video of the carousel video acquired, when the program channel opened is a carousel video.

In order to solve the foregoing technical problem, the present disclosure also discloses a device for displaying program information, including: a channel selection module adapted to detect an operation of opening a program channel in a live webcast homepage, the homepage comprising a plurality of program channels; and a program display module adapted to show a program list of the carousel video and a current program video of the carousel video acquired, when the program channel opened is a carousel video.

In order to solve the foregoing technical problem, the present disclosure also discloses a terminal apparatus, including: a processor; and a memory adapted to store instructions which are executable by the processor; wherein the processor is configured to: detect an operation of opening a program channel in a live webcast homepage, the homepage including a plurality of program channels; and show a program list of the carousel video and a current program video of the carousel video acquired, when the program channel opened is a carousel video.

Compared with the prior art, the embodiments of the present disclosure provide the method and the device for displaying program information, and the terminal apparatus. The current program video of the carousel video and the program list of the carousel video are showed when the user opens the carousel video, wherein the program information of the current program is showed in the middle of the program list, and the program information of the played programs and the programs to be played are showed at the two sides, which enable the user to intuitively understand the current playing progress of the carousel video, help the user determine whether to continuously watch the carousel video, push the played programs and programs to be played to the user for the user to select, enable the user to understand more program information of the carousel video timely, and provide more conveniences for watching the programs of the carousel video.

### BRIEF DESCRIPTION OF THE DRAWINGS

The drawings illustrated herein are used for providing further understanding of the present disclosure, which form a part of the present application. The exemplary embodiments of the present disclosure and the illustration thereof are used for explaining the present disclosure, and do not constitute improper limitations of the present disclosure. In the drawings:

FIG. 1 is a flow chart of a method for displaying program information provided by the embodiment of the present disclosure;

FIG. 2 is a flow chart of a method for displaying program information provided by the embodiment of the present disclosure;

FIG. 3 is a flow chart of a method for displaying program information provided by the embodiment of the present disclosure;

FIG. 4 is a flow chart of a method for displaying program information provided by the embodiment of the present disclosure;

FIG. 5 is a flow chart of a method for displaying program information provided by the embodiment of the present disclosure; and

FIG. 6 is a block diagram of a method for displaying program information provided by the embodiment of the present disclosure.

### DETAILED DESCRIPTION

The following detailed description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

According to the embodiments of the present disclosure, a program channel to be watched is selected after a live webcast homepage is opened; if the user selects to open a carousel video, then the current program of the carousel video is played, and the program list of the carousel video is displayed, wherein the program information of the current program is showed in the middle of the program list, and the program information of the played programs and the programs to be played are showed at the two sides, so that the user can intuitively understand the current playing progress of the carousel video; moreover, the played programs and programs to be played are pushed to the user for the user to select, so that the user can understand the program information of the carousel video timely, thus providing more conveniences for watching the programs of the carousel video.

FIG. 1 is a method for displaying program information provided by the embodiment of the present disclosure, which is applied to a terminal apparatus, wherein the terminal apparatus can be a mobile phone, a computer, a digital broadcast terminal, a messaging apparatus, an on-vehicle console, a gaming console, a tablet, a medical apparatus, a fitness apparatus, a personal digital assistant, or the like. As shown in FIG. 1, the method includes the following steps S101-S102.

In step S101, an operation of opening a program channel is detected in a live webcast homepage, the homepage including a plurality of program channels.

The terminal apparatus, after detecting an operation of a user of opening the live webcast homepage, loads and shows the live webcast homepage, wherein the data of the homepage can be acquired from a live-based server, or is already cached in the terminal apparatuslocally. The homepage includes a plurality of program channel entrances, for example, a satellite television channel, a live channel, a carousel video, or the like. The homepage can either be a homepage of a live video webcast website, or a homepage of a live webcast application.

The satellite television channel is used for the live telecast of programs played by satellite television channels of each television station. The live channel is used for playing online live programs, for example, those online live programs as an athletic contest, a social, a vocal concert, an electronic contest, or the like.

The carousel video is a channel which sequentially plays the programs with related contents in turn, wherein the program contents played in turn and the playing time of each program are all preset in a server, and the carousel video plays the corresponding programs in turn according to the settings. For example, a teleplay is played in one carousel video from the first episode to the last episode in turn, or each song of a vocal concert is respectively taken as a program and played in turn in the carousel video, or each contest of a team in recent period is taken as a program and played in turn in the carousel video, or the like.

In step S102, when the program channel opened is a carousel video, the program list of the carousel video and the current program video of the carousel video acquired are showed.

The data of the carousel video may be acquired through the following manners.

A. After an operation of opening the carousel video is detected, the program data of the carousel video is requested from the server. For example, after detecting that the user clicks the word or picture link of the carousel video, the terminal device requests the current program video and the program list of the carousel video from the server through a channel identity (ChannelID) of the carousel video. This manner of requesting according to the user selection can effectively save network bandwidth resources.

B. After opening a live webcast homepage, the current program videos of carousel videos in the homepage and the program list information of the carousel videos are automatically acquired, and the videos are cached for a preset time duration (for example, 30 s). When the user selects to open a certain carousel video, the video cached currently and the program list of the carousel video are showed, and the program videos of the carousel video are continuously acquired from the server. However, for other carousel videos, the corresponding caches thereof can be emptied and data acquisition is stopped; when the user closes the carousel video selected and returns to the homepage, the current videos of each carousel video are acquired again and cached. This manner of caching in advance can reduce the waiting time from opening the carousel video to starting playing the video, and improve the watching experience of the user.

C. After the user closes a certain carousel video, the cache data of the video of the carousel video acquired is reserved; however, the cache data has a preset life time (for example, 120 s), and the caches will be emptied if exceeding the life time. If the user opens the carousel video again in the life time, then the cached program video and the program list are played, and the videos of the carousel video are continuously acquired for playing. This manner is beneficial for caching the data of the carousel video opened when the user is selecting a carousel video, and avoiding excessive same requests from being repeatedly initiated.

The program list of the carousel video including the names and sequences of all the programs played in turn, the start time and end time of each program, or the like, is an interface object for interaction with the user, and includes the program information corresponding to the current program as well as the program information of the programs played before the current program and the program information of the programs to be played after the current program.

A player of a live webcast page or a build-in player of a live webcast application is called in to play the current program video of the carousel video, and meanwhile, the program list of the carousel video is displayed in a player interface. The program list displayed includes the program information of the current program as well as the program information of the programs played before the current program and the program information of the programs to be played after the current program. The program information includes, but is not limited to such information like program name, start time, performer, or the like. For example, the program information of the current program is showed in the middle of the program list displayed, so that the user can intuitively see the program information of the current program, so as to determine whether to continuously watch the current program. The program information of the played programs is at the left side of the program information of the current program, and the program information of the programs to be played is at the right side thereof, so that the user can understand the program playing sequence of the carousel video.

The current program, the played programs and the programs to be played of the carousel video can be determined according to the current time as well as the start time and end time of each program in the program list acquired.

Firstly, the start time and the end time of each program are respectively compared with the current time; if the start time or the end time are greater than the current time, the comparison result is recorded as −1; if the start time or the end time are equal to the current time, the comparison result is recorded as 0; and if the start time or the end time are less than the current time, the comparison result is recorded as 1.

For example, the start time of a program A is 19:30:00, and the end time is 19:41:59; the start time of a program B is 19:42:00, and the end time is 19:54:59; the start time of a program C is 19:55:00, and the end time is 19:59:59; and the current time is 19:45:30. Then, the comparison result of the start time of the program A and the current time is recorded as 1, and the comparison result of the end time and the current time is recorded as 1; the comparison result of the start time of the program B and the current time is recorded as 1, and the comparison result of the end time and the current time is recorded as −1; the comparison result of the start time of the program C and the current time is recorded as −1, and the comparison result of the end time and the current time is recorded as −1.

Then, each program is respectively marked according to the following conditions, and the programs are marked as current program, played program (or replaying program) or program to be played (or preemptive program):

(1) when the comparison result of the end time of the program is greater than −1, the program is marked as played program (or replaying program);

(2) when the comparison result of the start time of the program is greater than −1 and the comparison result of the end time is less than 0, the program is marked as current program; and

(3) when the comparison result of the start time of the program is less than 0, the program is marked as program to be played (or preemptive program).

To continue the foregoing example, the comparison result of the end time of the program A is 1, and the comparison result of the start time is also 1, which satisfy the foregoing condition (1); therefore, the program A is marked as played program (or replaying program); the comparison result of the end time of the program B is −1, and the comparison result of the start time is 1, which satisfy the foregoing condition (2); therefore, the program B is marked as current program; and the comparison result of the start time of the program C is −1, which satisfies the foregoing condition (3); therefore, the program C is marked as program to be played (or preemptive program).

The comparison result of the end time in condition (1) is greater than −1, which represents that the end time of the program is less than or equal to the current time, i.e., the program has been already played completely or just played completely; therefore, the program belongs to played program (or replaying program). The comparison result of the start time in condition (2) is greater than −1, which represents that the start time of the program is less than or equal to the current time, and the comparison result of the end time is less than 0, which represents that the end time of the program will be greater than the current time, i.e., the program has been completely played or just played but not played completely; therefore, the program belongs to current program. The comparison result of the start time in condition (3) is less than 0, which represents that the start time of the program is greater than the current time, i.e., the program is not played yet; therefore, the program belongs to program to be played (or preemptive program).

Through the above manners, all images in the program list can be marked, and the program information of the current program can be showed in the middle. The program list is an interface object for interaction with the user, and the user can look up the program information of all the programs in the program list through operations.

In the embodiment, after the user opens the carousel video, the current program video is played in the built-in player of the live webcast application, and meanwhile, the program list of the carousel video is displayed, wherein the program information of the current program is showed in the middle of the program list, and the program information of the played programs and the programs to be played are showed at the two sides, so as to enable the user to intuitively understand the current playing progress of the carousel video, help the user determine whether to continuously watch the carousel video, and push the played programs and programs to be played to the user for the user to select, so that the user can understand more program information of the carousel video timely, thus providing more conveniences for watching the program of the carousel video.

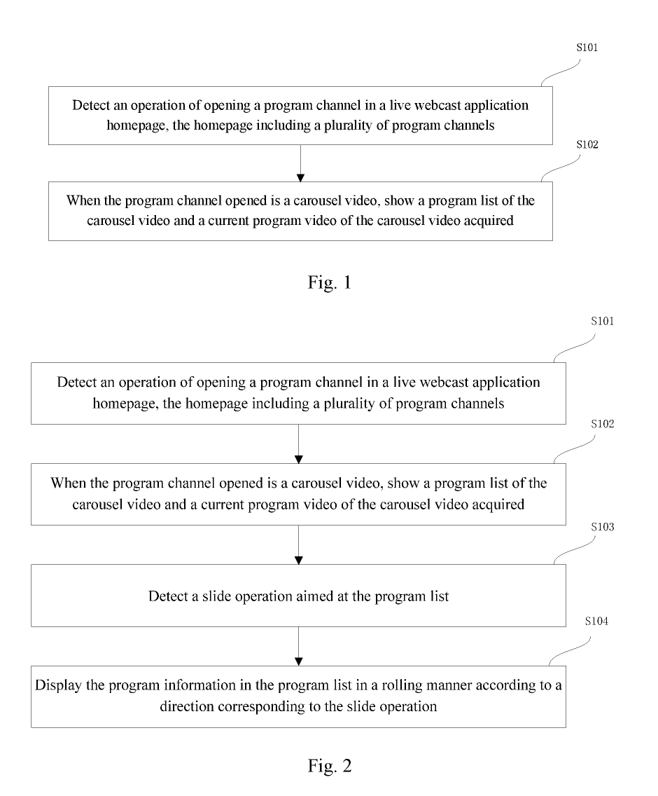

In one embodiment, as shown in FIG. 2, the method further includes the following steps S103-S104.

In step S103, a slide operation direct to the program list is detected. In step S104, the program information in the program list is displayed in a rolling manner according to a direction corresponding to the slide operation.

The program list is used as an interface object for interaction with the user, and the user can perform a slide operation aimed at the program list so as to browse the program information of all the programs in the program list. For example, the program information of the current program is showed in the middle, the program information of the played programs is showed at the left, and the program information of the programs to be played is showed at the right; when sliding the program list to the left, the user can browse more played programs, while when sliding the program list to the right, the user can browse more programs to be played.

In the embodiment, while playing the current program, the user can look up all the programs of the carousel video by an operation of controlling the program list to roll front and back, so as to determine whether the carousel video has programs that are expected by the user, and know the time for playing the program, thus providing convenience for the user to watch the programs of the carousel video.

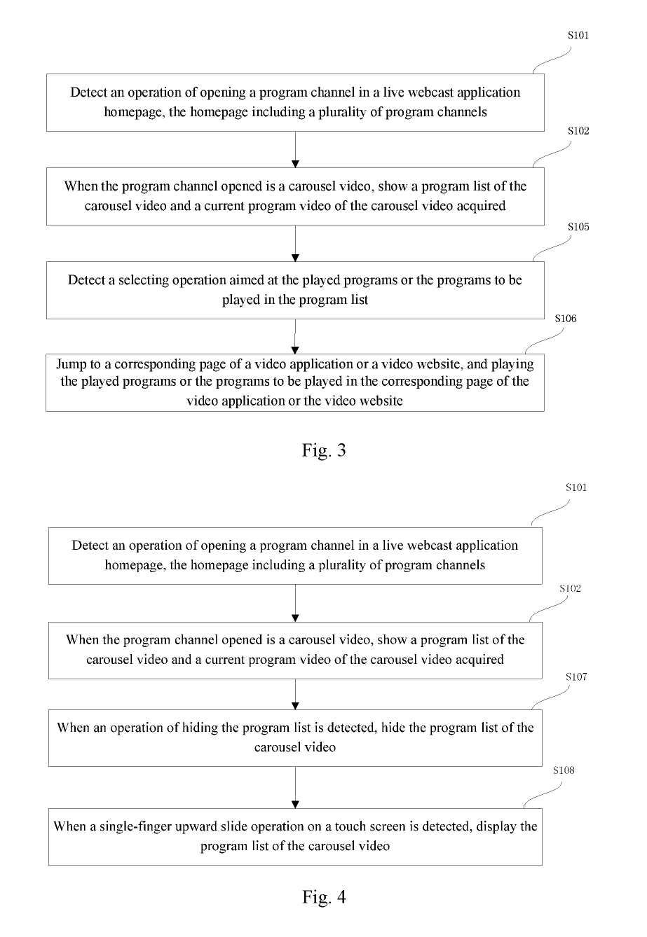

In one embodiment, as shown in FIG. 3, the method further includes the following steps S105-S106.

In step S105, a selecting operation aimed at played programs or programs to be played is detected.

In step S106, it is jumped to a corresponding page of a video application or a video website, and the played programs or the programs to be played are played in the corresponding page of the video application or the video website.

The user may also select a program to be watched through the program list; if the user finds a program to be watched in the played programs or the programs to be played in the program list, the user may click the program name or the thumbnail of the program in the program list to select the program.

Because the current playing program contents of the carousel video depend on the setting of the server, when the user selects other programs in the program list, the terminal apparatus needs to jump to the corresponding pages of other video applications or video websites to play the program selected by the user.

For example, the current program played in the carousel video is the tenth episode of a teleplay ABC; the user only has watched the front two episodes, and does not know other stories of the teleplay before the tenth episode. Then, the user finds the third episode of the teleplay from the program list of the carousel video and clicks to select watching, and the terminal apparatus jumps to the page of the third episode of the teleplay ABC of other video application (for example, LeTV Video) or video website (for example, LeTV Net) and starts playing the third episode. While the built-in player of the live webcast application stops playing the programs of the carousel video at the backstage temporarily; when the user returns to the live webcast application again and enters the carousel video, the current program video is requested from the server again.

In the embodiment, because the current playing contents of the carousel video are uniformly determined by the server, when the user selects to watch other programs in the program list of the carousel video, the playing contents of the carousel video cannot be changed; at this moment, it is desirable to jump to other video application or video website to request a corresponding video resource and play the video resource to the user, so as to help the user review the played programs of the carousel video or watch the programs to be played in advance, so that the flexibility of the user for watching the programs of the carousel video is further improved.

In one embodiment, as shown in FIG. 4, the method further includes the following steps S107-S108.

In step S107, when an operation of hiding the program list is detected, the program list of the carousel video is hidden.

In step S108, when a single-finger upward slide operation on a touch screen is detected, the program list of the carousel video is displayed.

If the user feels that the program list of the carousel video has influence on watching the current program video, then the program can be hidden through operation. For example, a button for hiding on the program list is clicked, or the screen is clicked in an area excluding the display area of the program list to trigger an instruction of hiding the program list.

After the program list is hidden, if the user wants to display the program list again and browse the program information, the display of the program list can be restored through a single-finger upward slide on a touch screen, and the program information of the current program is still displayed in the middle of the restored program list.

In the embodiment, the user can hide the program list of the carousel video and restore to display the program list through a manual operation, so that the user interaction is friendlier.

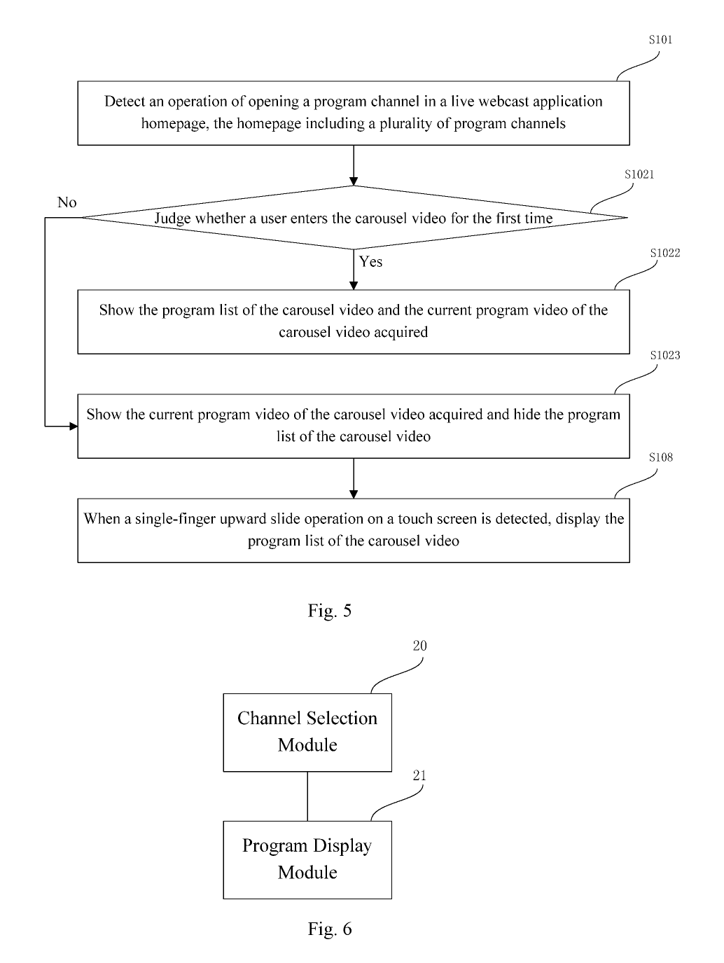

In one embodiment, as shown in FIG. 5, step S102 can be further implemented as the following steps S1021-S1023.

In step S1021, it is judged whether a user enters the carousel video for the first time. When the user enters the carousel video for the first time, step S1022 is performed; and when the user does not enter the carousel video for the first time, step S1023 is performed.

In step S1022, the program list of the carousel video and the current program video of the carousel video acquired are showed.

In step S1023, the current program video of the carousel video acquired is showed and the program list of the carousel video is hidden.

It is judged whether the user enters the carousel video for the first time according to a user identity (UserID) logged in a live video webcast website or a live webcast application as well as a playing record corresponding to the user identity. When the user enters the carousel video for the first time, the program list of the carousel video is displayed while playing the current program video, so that the user can understand that the carousel video has the interactive program list function, which plays a prompting effect for guiding the user to use the program list, while when the user does not enter the carousel video for the first time, the program list is hidden; if the user wants to use the program list, the user can restore to display the program list through a single-finger upward slide operation on the touch screen as mentioned in step S109.

In the embodiment, when the user enters the carousel video for the first time, the program list of the carousel video is showed, so that the user can understand that the carousel video has the interactive program list function, so as to prompt the user to use the function to browse and look up the program information, while when the user does not enter the carousel video for the first time, it is deemed that the user has known the program list function, and the program list is hidden; when the user wants to use the program list, the user can restore to show the program list through a single-finger upward slide operation on the touch screen, so that the user interaction is more intelligentized and humanized.

Embodiments of devices of the present application are described hereinafter, which may be used for performing embodiments of methods of the present application.

FIG. 6 is a block diagram of a device for displaying program information provided by the embodiment of the present disclosure. The device may become a part or all of an electronic apparatus through software, hardware or a combination thereof. The device includes: a channel selection module 20 and a program display module 21.

The channel selection module 20 is electrically connected with the program display module 21, and is adapted to detect an operation of opening a program channel in a live webcast homepage, the homepage including a plurality of program channels; and

the program display module 21 is adapted to, when the program channel opened is a carousel video, show a program list of the carousel video and a current program video of the carousel video acquired.

In one embodiment, the device further includes: a slide detection module and a program list rolling module.

The slide detection module is electrically connected with the program display module 21, and is adapted to detect a slide operation aimed at the program list;

the program list rolling module is electrically connected with the slide detection module, and is adapted to display the program information in the program list in a rolling manner according to a direction corresponding to the slide operation.

In one embodiment, the device further includes: a program selection module and a page jumping module.

The program selection module is electrically connected with the program display module 21, and is adapted to detect a selecting operation aimed at the played programs or the programs to be played in the program list; and

the page jumping module is electrically connected with the program selection module, and is adapted to jump to a corresponding page of a video application or a video website, and play the played programs or the programs to be played in the corresponding page of the video application or the video website.

In one embodiment, the device further includes: a program list hiding module.

The program list hiding module is electrically connected with the program display module 21, and is adapted to, when an operation of hiding the program list is detected, hide the program list of the carousel video.

In one embodiment, the program display module 21 further includes: a judgment submodule, a first display submodule and a second display submodule.

The judgment submodule is electrically connected with the first display submodule and the second display submodule respectively, and is adapted to judge whether a user enters the carousel video for the first time;

the first display submodule is adapted to, when the user enters the carousel video the first time, show the program list of the carousel video and the current program video of the carousel video acquired; and

the second display submodule is adapted to, when the user does not enter the carousel video for the first time, show the current program video of the carousel video acquired and hide the program list of the carousel video.

In one embodiment, the device further includes: a program list display module.

The program list display module is electrically connected with the program list hiding module and the second display submodule, and is adapted to, when a single-finger upward slide operation on a touch screen is detected, display the program list of the carousel video.

Furthermore, each functional module above-mentioned in the embodiments of the present disclosure can be implemented through a hardware processor.

The embodiments of the present disclosure also provide a terminalapparatus, the terminal apparatus including: a processor and a memory adapted to store instructions executable by the processor; wherein the processor is configured to:

detect an operation of opening a program channel in a network broadcast homepage, the homepage including a plurality of program channels; and when the program channel opened is a carousel video, show a program list of the carousel video and a current program video of the carousel video acquired.

In one embodiment, the processor is further configured to detect a slide operation aimed at the program list; and display the program information in the program list in a rolling manner according to a direction corresponding to the slide operation.

In one embodiment, the processor is further configured to detect a selecting operation aimed at the played programs or the programs to be played; and jump to a corresponding page of a video application or a video website, and play the played programs or the programs to be played in the corresponding page of the video application or the video website.

In one embodiment, the processor is further configured to, when an operation of hiding the program list is detected, hide the program list of the carousel video.

In one embodiment, showing the program list of the carousel video and the current program video of the carousel video acquired when the program channel opened is a carousel video includes: judging whether a user enters the carousel video for the first time; when the user enters the carousel video for the first time, showing acquired the current program video of the carousel video and the program list of the carousel video; and when the user does not enter the carousel video for the first time, showing the current program video of the carousel video acquired and hiding the program list of the carousel video.

In one embodiment, the processor is further configured to, when a single-finger upward slide operation on a touch screen is detected, display the program list of the carousel video.

The device embodiments described above are only exemplary, wherein the units illustrated as separate components may either be or not physically separated, and the components displayed as units may either be or not physical units, i.e., the components may either be located in the same plate, or be distributed on a plurality of network units. A part or all of the modules may be selected according to an actual requirement to achieve the objectives of the solutions in the embodiments. Those skilled in the art may understand and implement without going through creative work.

The above-mentioned illustration shows and describes the embodiments of the present application, but as previously mentioned, it should be understood that the present application is not limited to the forms disclosed in this text, and should not be regarded as the exclusion of other embodiments, but may be used for a variety of other combinations, modifications and circumstances, and can be modified within the scope of the conception of disclosure in this text through the above-mentioned teaching or knowledge or technology of related field. The modifications and variations made by those skilled in the art without departing from the spirit and scope of the present application shall all fall within the scope of pretection of the appended claims of the present application.

1. A method for displaying program information, comprising:
detecting an operation of opening a program channel in a live webcast homepage, the homepage comprising a plurality of program channels; and
showing a program list of the carousel video and a current program video of the carousel video acquired, when the program channel opened is a carousel video.

2. The method according to claim 1, further comprising:
detecting a slide operation aimed at the program list; and
displaying the program information in the program list in a rolling manner according to a direction corresponding to the slide operation.

3. The method according to claim 1, further comprising:
detecting a selecting operation aimed at played programs or programs to be played in the program list; and
jumping to a corresponding page of a video application or a video website, and playing the played programs or the programs to be played in the corresponding page of the video application or the video website.

4. The method according to claim 1, further comprising:
hiding the program list of the carousel video, when an operation of hiding the program list is detected.

5. The method according to claim 1, wherein the showing the program list of the carousel video and the current program video of the carousel video acquired when the program channel opened is a carousel video comprises:
judging whether a user enters the carousel video for the first time;
showing the program list of the carousel video and the current program video of the carousel video acquired, when the user enters the carousel video for the first time; and
showing the current program video of the carousel video acquired and hiding the program list of the carousel video, when the user does not enter the carousel video for the first time.

6. The method according to claim 4, wherein when the program list of the carousel video is hidden, the method further comprises:
displaying the program list of the carousel video, when a single-finger upward slide operation on a touch screen is detected.

7. A device for displaying program information, comprising:
a channel selection module adapted to detect an operation of opening a program channel in a live webcast homepage, the homepage comprising a plurality of program channels; and
a program display module adapted to show a program list of the carousel video and a current program video of the carousel video acquired, when the program channel opened is a carousel video.

8. The device according to claim 7, further comprising:
a slide detection module adapted to detect a slide operation aimed at the program list; and
a program list rolling module adapted to display the program information in the program list in a rolling manner according to a direction corresponding to the slide operation.

9. The device according to claim 7, further comprising:
a program selection module adapted to detect a selecting operation aimed at played programs or programs to be played in the program list; and
a page jumping module adapted to jump to a corresponding page of a video application or a video website, and play the played programs or the programs to be played in the corresponding page of the video application or the video website.

10. The device according to claim 7, further comprising:
a program list hiding module adapted to hide the program list of the carousel video, when an operation of hiding the program list is detected.

11. The device according to claim 7, wherein the program display module comprises:
a judgment submodule adapted to judge whether a user enters the carousel video for the first time;
a first display submodule adapted to show the program list of the carousel video and the current program video of the carousel video acquired, when the user enters the carousel video for the first time; and
a second display submodule adapted to show the current program video of the carousel video acquired and hide the program list of the carousel video, when the user does not enter the carousel video for the first time.

12. The device according to claim 10, further comprising:
a program list display module adapted to display the program list of the carousel video, when a single-finger upward slide operation on a touch screen is detected.

13. A terminal apparatus, comprising:
a processor; and
a memory adapted to store instructions which are executable by the processor;
wherein the processor is configured to:
detect an operation of opening a program channel in a live webcast homepage, the homepage comprising a plurality of program channels; and
show a program list of the carousel video and a current program video of the carousel video acquired, when the program channel opened is a carousel video.

14. The apparatus according to claim 13, wherein the processor is further configured to:
detect a slide operation aimed at the program list; and
display the program information in the program list in a rolling manner according to a direction corresponding to the slide operation.

15. The apparatus according to claim 13, wherein the processor is further configured to:
detect a selecting operation aimed at the played programs or the programs to be played; and
jump to a corresponding page of a video application or a video website, and play the played programs or the programs to be played in the corresponding page of the video application or the video website.

16. The apparatus according to claim 13, wherein the processor is further configured to:
hide the program list of the carousel video, when an operation of hiding the program list is detected.

17. The apparatus according to claim 13, wherein the showing the program list of the carousel video and the current program video of the carousel video acquired when the program channel opened is a carousel video comprises:
judging whether a user enters the carousel video for the first time;
showing acquired the current program video of the carousel video and the program list of the carousel video when the user enters the carousel video for the first time; and
showing the current program video of the carousel video acquired and hiding the program list of the carousel video, when the user does not enter the carousel video for the first time.

18. The apparatus according to claim 16, wherein the processor is further configured to:
display the program list of the carousel video, when a single-finger upward slide operation on a touch screen is detected.
